(19) United States
(12) Patent Application Publication
(10) Pub. No.: US 2026/0018050 A1
(43) Pub. Date: Jan. 15, 2026

(54) INFORMATION PROCESSING APPARATUS

(71) Applicant: TOYOTA JIDOSHA KABUSHIKI KAISHA, Toyota-shi (JP)

(72) Inventors: Hiromi TONEGAWA, Kounan-shi (JP); Yoshi KONDO, Kariya-shi (JP); Makoto TAMURA, Ohta-ku (JP); Haruna TAKASUGI, Nagoya-shi (JP)

(73) Assignee: TOYOTA JIDOSHA KABUSHIKI KAISHA, Toyota-shi (JP)

(21) Appl. No.: 19/256,706

(22) Filed: Jul. 1, 2025

(30) Foreign Application Priority Data
Jul. 10, 2024 (JP) 2024-111041

(51) Int. Cl. G08G 1/01

(52) U.S. Cl. CPC G08G 1/0133; G08G 1/0112; G08G 1/0129; G08G 1/0145

(57) ABSTRACT

An information processing apparatus determines whether or not the number of traveling vehicles in an evaluation section in an evaluation period for evaluating a likelihood of being stuck exceeds a threshold. The information processing apparatus extends the evaluation period in a case where the number of the traveling vehicles is less than the threshold. Then, in a case where the number of the traveling vehicles exceeds the threshold, the information processing apparatus evaluates the likelihood of being stuck in the evaluation section in accordance with probe information when a plurality of the traveling vehicles is traveling in the evaluation section.

### CROSS REFERENCE TO THE RELATED APPLICATION

This application claims the benefit of Japanese Patent Application No. 2024-111041, filed on Jul. 10, 2024, which is hereby incorporated by reference herein in its entirety.

### BACKGROUND

### Technical Field

The present disclosure relates to an information processing apparatus.

### Description of the Related Art

Japanese Patent Laid-Open No. 2022-24312 discloses a driving assistance apparatus. The driving assistance apparatus disclosed in Japanese Patent Laid-Open No. 2022-24312 acquires vehicle speed data before an ABS of a vehicle is activated and vehicle speed data when the ABS of the vehicle is stopped. The driving assistance apparatus calculates a coefficient of sliding friction based on the vehicle speed data before the ABS is activated and the vehicle speed data when the ABS is stopped. The driving assistance apparatus determines whether or not the coefficient of sliding friction is equal to or smaller than a threshold and detects that a slip due to road freezing has occurred in a case where the coefficient of sliding friction is equal to or smaller than the threshold.

Japanese Patent No. 7282994 discloses an emergency traffic regulation decision support system. The emergency traffic regulation decision support system disclosed in JP Patent No. 7282994 acquires information on a road surface condition including bumps on a road surface due to snow accumulation, snow quality on the road surface or freezing of the road surface. Further, the emergency traffic regulation decision support system acquires information on a road space condition including information regarding whether or not there is an avalanche, a snowdrift, snow drifting or a stuck vehicle. Further, the emergency traffic regulation decision support system acquires information on a vehicle traveling condition including wheelspin due to snow accumulation, sudden braking or sideslip. The emergency traffic regulation decision support system analyzes the road surface condition due to snow accumulation, the road space condition, and the vehicle traveling condition in accordance with the acquired information. Then, the emergency traffic regulation decision support system comprehensively determines an emergency traffic regulation based on the analysis result.

### SUMMARY

An object of the present disclosure is to evaluate a likelihood of being stuck on a road more reliably.

An information processing apparatus according to a first aspect of the present disclosure includes a controller configured to execute:
determining whether or not the number of traveling vehicles in an evaluation section in an evaluation period for evaluating a likelihood of being stuck exceeds a threshold;
extending the evaluation period in a case where the number of the traveling vehicles is less than the threshold;
in a case where the number of the traveling vehicles exceeds the threshold, evaluating a likelihood of being stuck in the evaluation section in accordance with probe information when a plurality of the traveling vehicles is traveling in the evaluation section; and
outputting result information of the evaluation.

An information processing apparatus according to a second aspect of the present disclosure includes a controller configured to execute:
receiving in real time, probe information including a position acquired by a GPS device mounted on each of vehicles and a sensing value acquired by an in-vehicle sensor of each of the vehicles;
storing the probe information of the vehicles in a database;
specifying traveling vehicles in an evaluation section in an evaluation period for evaluating a likelihood of being stuck with reference to positions of the vehicles stored in the database;
extending the evaluation period in a range up to an evaluation time limit in a case where the number of the traveling vehicles is less than a threshold;
in a case where the number of the traveling vehicles exceeds the threshold, evaluating a likelihood of being stuck in the evaluation section in accordance with probe information when a plurality of the traveling vehicles is traveling in the evaluation section, the probe information being stored in the database; and
outputting result information of the evaluation to an external apparatus.

According to the present disclosure, it is possible to evaluate a likelihood of being stuck on a road more reliably.

### BRIEF DESCRIPTION OF THE DRAWINGS

FIG. 1 is a diagram illustrating a schematic configuration of an evaluation system according to the present embodiment;

FIG. 2 is a diagram indicating an example of a relationship among an evaluation period, an evaluation time limit, and a provision time;

FIG. 3 is a block diagram schematically illustrating an example of a functional configuration of an evaluation server;

FIG. 4 is a diagram indicating an example of a table configuration of probe information held in a probe information database;

FIG. 5 is a diagram indicating an example of a table configuration of evaluation information held in an evaluation information database; and

FIG. 6 is a flowchart of processing to be executed by a controller.

### DESCRIPTION OF THE EMBODIMENTS

A case will be assumed where a likelihood of being stuck on a road is evaluated using probe information of vehicles. In this event, there is a case where probe information of a sufficient number of vehicles cannot be acquired to evaluate a likelihood of being stuck on the road using the probe information of the vehicles. Thus, there is a case where a likelihood of being stuck cannot be evaluated using the probe information of the vehicles. An information processing apparatus according to a first aspect of the present disclosure solves such a problem.

A controller of the information processing apparatus according to the first aspect of the present disclosure determines whether or not the number of traveling vehicles in an evaluation section in an evaluation period for evaluating a likelihood of being stuck exceeds a threshold. The controller of the information processing apparatus extends the evaluation period in a case where the number of the traveling vehicles is less than the threshold. Further, in a case where the number of the traveling vehicles exceeds the threshold, the controller evaluates a likelihood of being stuck in the evaluation section in accordance with probe information when a plurality of the traveling vehicles is traveling in the evaluation section. In other words, the controller extends the evaluation period in a case where the number of the traveling vehicles in the evaluation period is less than the threshold, and in a case where the number of the traveling vehicles in the extended evaluation period exceeds the threshold, evaluates a likelihood of being stuck in accordance with probe information. Then, the controller outputs result information of the evaluation.

As described above, by the information processing apparatus, in a case where the number of the traveling vehicles in the evaluation period is less than the threshold, the evaluation period is extended. This helps, even in a case where the number of traveling vehicles existing in the evaluation period is not sufficient to evaluate a likelihood of being stuck in accordance with the probe information, to secure a sufficient number of traveling vehicles by extending the evaluation period. This can prevent the evaluation of the likelihood of being stuck from being impossible. As a result, it is possible to evaluate a likelihood of being stuck on a road more reliably.

Specific embodiments of the present disclosure will be described below based on the drawings. A hardware configuration, a module configuration, a functional configuration, and the like, described in each embodiment are not intended to limit a technical scope of the disclosure thereto unless otherwise specified.

### Embodiment

### (Outline of System)

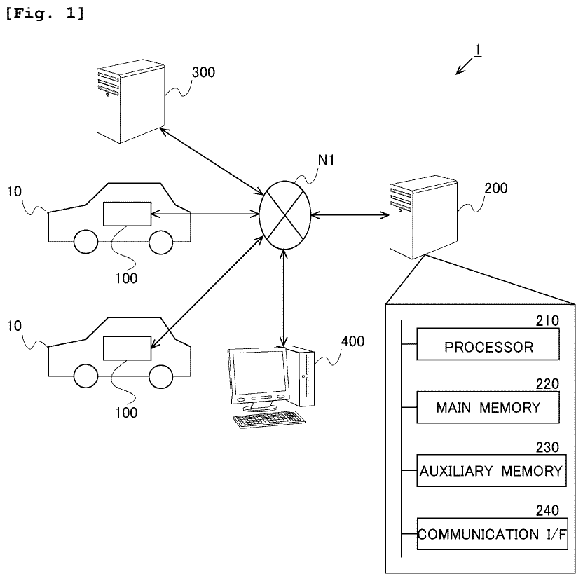

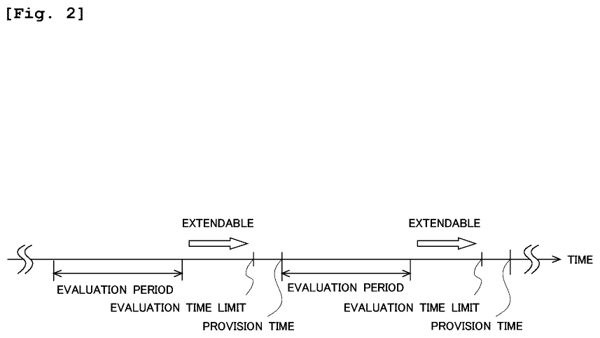

An evaluation system 1 in the present embodiment will be described based on FIG. 1 and FIG. 2. FIG. 1 is a diagram illustrating a schematic configuration of the evaluation system 1 according to the present embodiment. The evaluation system 1 includes a plurality of in-vehicle devices 100, an evaluation server 200, an external server 300, and a user terminal 400. In the evaluation system 1, the plurality of in-vehicle devices 100, the evaluation server 200, the external server 300, and the user terminal 400 are connected to one another by a network N1. As the network N1, for example, a wide area network (WAN) which is a worldwide public communication network such as the Internet, or a telephone communication network of a mobile phone or the like, may be employed.

### (In-Vehicle Device)

The in-vehicle device 100 is a device mounted on a vehicle 10. The in-vehicle device 100 acquires position information of the vehicle 10 in real time from a GPS device. Further, the in-vehicle device 100 acquires a wheel speed of the vehicle 10 in real time from a wheel speed sensor of the vehicle 10. Then, the in-vehicle device 100 transmits probe information of the vehicle 10 to the evaluation server 200 in real time via the network N1. Here, the probe information includes information indicating the position and the wheel speed of the vehicle 10. The in-vehicle device 100 transmits the probe information of the vehicle 10 to the evaluation server 200 in real time via the network N1.

### (External Server)

The external server 300 is a server device that provides information on a road surface condition (which may be hereinafter also referred to as “road surface condition information”). Here, the road surface condition information includes information on a weather condition (condition of whether or not there is rainfall or snowfall, or an amount of rainfall, an amount of snowfall, and the like), a snow clearance condition, a condition of spraying of a snow melting agent or an anti-freezing agent, and the like, on the road. The external server 300 transmits the road surface condition information to the evaluation server 200 via the network N1.

### (Evaluation Server)

The evaluation server 200 is a server device that evaluates a likelihood of being stuck on the road. The evaluation server 200 receives the probe information from the plurality of in-vehicle devices 100 via the network N1. The evaluation server 200 evaluates the likelihood of being stuck on the road with reference to the probe information received from the plurality of in-vehicle devices 100. Specifically, the evaluation server 200 specifies vehicles 10 (which may be hereinafter referred to as “traveling vehicles 10”) that have traveled in an evaluation section in an evaluation period. Here, the evaluation section is a section in which the likelihood of being stuck on the road is to be evaluated. Further, the evaluation period is a period during which the probe information of the vehicles 10 that have traveled in the evaluation section is collected.

In this event, there is a case where the number of traveling vehicles 10 that have traveled in the evaluation section in the evaluation period is not sufficient to evaluate the likelihood of being stuck on the road in accordance with the probe information. Thus, the evaluation server 200 extends an information collection period in a case where the number of traveling vehicles 10 that have traveled in the evaluation section is less than a threshold in the information collection period. Here, the threshold is determined as the number of vehicles sufficient to evaluate the likelihood of being stuck on the road in accordance with the probe information.

On the other hand, the evaluation server 200 is configured to provide an evaluation result of the likelihood of being stuck on the road in the evaluation section (which may be hereinafter simply referred to as an “evaluation result”) at a time determined in advance (which may be hereinafter referred to as a “provision time”). Thus, if the evaluation period is unlimitedly extended, there is a case where the evaluation result cannot be provided until the provision time. Thus, a time serving as a time limit (which may be hereinafter referred to as an “evaluation time limit”) is set for extension of the evaluation period.

FIG. 2 is a diagram indicating an example of a relationship among the evaluation period, the evaluation time limit, and the provision time. As indicated in FIG. 2, the evaluation period is determined. Further, the evaluation time limit is set so as to come before the provision time. The evaluation time limit is determined such that evaluation processing of a likelihood of being stuck can be performed until the provision time. Further, the next evaluation period is set at the provision time. In this manner, in the present embodiment, setting of the evaluation period is repeatedly performed.

The evaluation server 200 extends the evaluation period up to the evaluation time limit in a case where the number of traveling vehicles 10 in the evaluation period is less than the threshold. Here, the evaluation period can be extended up to the evaluation time limit. The evaluation server 200 extends the evaluation period at least once in a case where the number of the traveling vehicles 10 in the evaluation period is less than the threshold.

In a case where the number of the traveling vehicles 10 in the evaluation period (including the extended evaluation period) is equal to or larger than the threshold, the evaluation server 200 evaluates the likelihood of being stuck in the evaluation section in accordance with the probe information of the traveling vehicles 10 in the evaluation period. Here, there is a case where the number of the traveling vehicles 10 is less than the threshold even if the evaluation period is extended up to the evaluation time limit. In this case, the evaluation server 200 acquires the road surface condition information in the evaluation section in the evaluation period from the external server 300 and evaluates the likelihood of being stuck in the evaluation section in accordance with the road surface condition. A method in which the evaluation server 200 evaluates the likelihood of being stuck in the evaluation section in accordance with the probe information or the road surface condition of the evaluation section in the evaluation period will be described in detail later.

The evaluation server 200 is constituted with a computer including a processor 210, a main memory 220, an auxiliary memory 230, and a communication interface (communication I/F) 240. The processor 210 is, for example, a central processing unit (CPU) or a digital signal processor (DSP). The main memory 220 is, for example, a random access memory (RAM). The auxiliary memory 230 is, for example, a read only memory (ROM). Further, the auxiliary memory 230 is, for example, a hard disk drive (HDD) or a disk recording medium like a CD-ROM, a DVD disk or a Blu-ray Disc. Still further, the auxiliary memory 230 may be a removable medium (removable storage medium). Here, examples of the removable medium can include a USB memory or an SD card. The communication I/F 240 is, for example, a local area network (LAN) interface board or a wireless communication circuit for wireless communication.

In the evaluation server 200, an operating system (OS), various kinds of programs, various kinds of information tables, and the like are stored in the auxiliary memory 230. Further, in the evaluation server 200, the processor 210 can implement various kinds of functions as will be described later by loading the programs stored in the auxiliary memory 230 to the main memory 220 and executing the programs. However, some or all of the functions in the evaluation server 200 may be implemented by a hardware circuit like an ASIC or an FPGA. Note that the evaluation server 200 does not necessarily have to be implemented by a single physical component and may be constituted with a plurality of computers coordinating with each other. Note that the in-vehicle device 100, the external server 300 and the user terminal 400 may also include a computer in a similar manner to the evaluation server 200.

### (User Terminal)

The user terminal 400 is a terminal related to a user who receives delivery of an evaluation result of a likelihood that a vehicle will be stuck. Here, the terminal related to the user is, for example, a computer or a mobile information terminal to be used by the user. Further, the terminal related to the user may be, for example, an in-vehicle device such as a navigation system mounted on the vehicle to be used by the user. The user terminal 400 receives result information from the evaluation server 200 via the network N1. Here, the result information is information including the evaluation result of the likelihood of being stuck in the evaluation section. The user terminal 400 displays the received result information on a display. This allows the user to grasp the likelihood of being stuck in the evaluation section.

### (Functional Configuration)

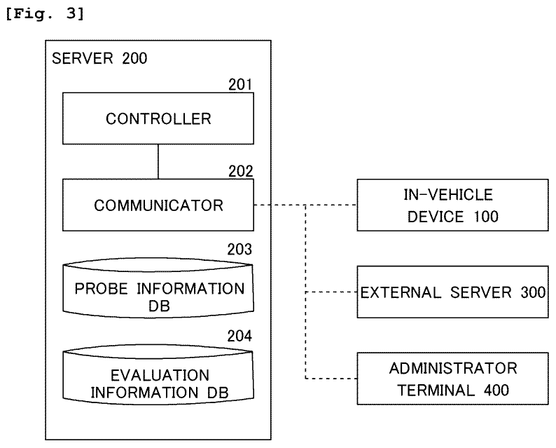

A functional configuration of the evaluation server 200 constituting the evaluation system 1 will be described next in accordance with FIG. 3 to FIG. 5. FIG. 3 is a block diagram schematically illustrating an example of the functional configuration of the evaluation server 200. The evaluation server 200 includes a controller 201, a communicator 202, a probe information database 203 (probe information DB 203), and an evaluation information database 204 (evaluation information DB 204).

The controller 201 has a function of performing arithmetic processing for controlling the evaluation server 200. The controller 201 can be implemented by the processor 210 in the evaluation server 200. The communicator 202 has a function of connecting the evaluation server 200 to the network N1. The controller 201 can be implemented by the communication I/F 240 in the evaluation server 200.

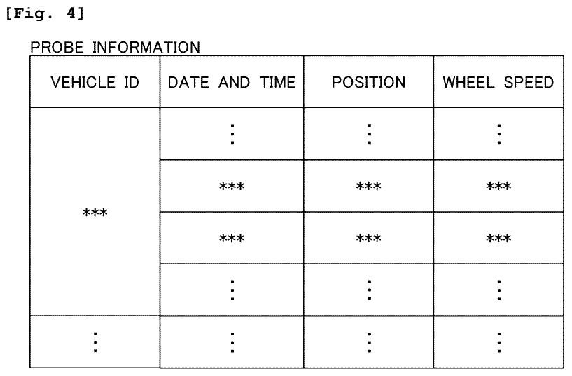

The controller 201 receives probe information from the plurality of in-vehicle devices 100 via the communicator 202. The controller 201 stores the received probe information in the probe information DB 203. The probe information DB 203 can be implemented by the auxiliary memory 230 in the evaluation server 200. FIG. 4 is a diagram indicating an example of a table configuration of the probe information held in the probe information DB 203.

As indicated in FIG. 4, the probe information held in the probe information DB 203 has a vehicle ID field, a date and time field, a position field, and a wheel speed field. The vehicle ID field stores an identifier (vehicle ID) for specifying a vehicle on which the in-vehicle device that has transmitted the probe information is mounted. The date and time field stores information indicating date and time at which the probe information has been transmitted. The position field stores information indicating a position of the vehicle at the date and time at which the probe information has been transmitted. The position field stores, for example, latitude and longitude. The wheel speed field stores information indicating a wheel speed at the date and time at which the probe information has been transmitted. The wheel speed field stores information indicating a wheel speed of each of four wheels of the vehicle. The wheel speed of each of the four wheels of the vehicle is, for example, an angular velocity of each wheel.

Here, in a case where the vehicle is traveling on a road on which the vehicle is likely to be stuck, the wheel is likely to wheelspin. Thus, in a case where the vehicle is traveling on a road on which the vehicle is likely to be stuck, it is assumed that a wheel speed difference (a value obtained by subtracting a minimum wheel speed from a maximum wheel speed) becomes large. Thus, the controller 201 evaluates a likelihood that the vehicle will be stuck using the wheel speed difference.

The controller 201 specifies vehicles (traveling vehicles 10) that have traveled in the evaluation section in the evaluation period with reference to the date and time field and the position field in the probe information held in the probe information DB 203. Then, the controller 201 determines whether or not the number of the traveling vehicles 10 is equal to or larger than the threshold. In a case where the number of the traveling vehicles 10 is equal to or larger than the threshold, the controller 201 evaluates the likelihood that the vehicle will be stuck in the evaluation section using the probe information of the traveling vehicles 10, the number of which is equal to or larger than the threshold.

Specifically, the controller 201 calculates an average value of the wheel speed differences of the traveling vehicles 10, the number of which is equal to or larger than the threshold. Here, an associated evaluation value of the likelihood of being stuck is set to each average value of the wheel speed differences. The controller 201 determines the evaluation value associated with the calculated average value of the wheel speed differences as the evaluation result.

In a case where the number of the traveling vehicles 10 is less than the threshold, the controller 201 extends the evaluation period once or a plurality of times until the evaluation time limit comes. In a case where the extended evaluation period ends, the controller 201 determines whether or not the number of the traveling vehicles 10 in the extended evaluation period is equal to or larger than the threshold.

In a case where the number of the traveling vehicles 10 in the extended evaluation period is equal to or larger than the threshold, the controller 201 evaluates the likelihood that the vehicle will be stuck in the evaluation period using the probe information of the traveling vehicles 10, the number of which is equal to or larger than the threshold in the evaluation period. Further, in a case where the number of the traveling vehicles 10 in the extended evaluation period is less than the threshold, and the extended evaluation period is not extended up to the evaluation time limit, the controller 201 extends the evaluation period.

Further, there is a case where the number of the traveling vehicles 10 is less than the threshold even if the evaluation period is extended up to the evaluation time limit. In the present embodiment, the evaluation section is set for each lane. In the present embodiment, a case will be described where the evaluation section is set for each of two lanes (an up lane and a down lane). In this event, it is assumed that the up lane and the down lane are similar in a road surface condition compared to other road sections. Thus, in a case where a predetermined condition is satisfied, the controller 201 evaluates the likelihood that the vehicle will be stuck in the evaluation section in which the number of the traveling vehicles 10 is less than the threshold, further using the probe information of the traveling vehicles 10 in the evaluation section of the adjacent lane.

The predetermined condition is that a total number of the number of the traveling vehicles 10 in the evaluation period and the number of the traveling vehicles 10 in the evaluation section of the adjacent lane (which may be hereinafter referred to as a “total number”) is equal to or larger than the threshold. The controller 201 determines whether or not the total number is equal to or larger than the threshold. Then, in a case where the total number is equal to or larger than the threshold, the controller 201 evaluates the likelihood of being stuck in the evaluation section (the section in which the number of the traveling vehicles 10 is less than the threshold) in accordance with the probe information of the traveling vehicles 10 in the evaluation section and the traveling vehicles 10 in the evaluation section of the adjacent lane. This makes it possible to evaluate the likelihood of being stuck using the probe information even in a case where the number of the traveling vehicles 10 is less than the threshold. Note that in a case where the evaluation section is set for each of three or more lanes, the controller 201 evaluates the likelihood of being stuck using the probe information of the traveling vehicles 10 in the evaluation sections of the three or more lanes.

In a case where the total number is less than the threshold, the controller 201 acquires road surface condition information from the external server 300. Then, the controller 201 evaluates the likelihood that the vehicle will be stuck in the evaluation section in accordance with the road surface condition information.

Specifically, the controller 201 acquires an amount of snowfall in the evaluation section in the evaluation period with reference to the weather information in the road surface condition information. Further, in a case where there is snowfall in the evaluation section in the evaluation period, the controller 201 estimates an amount of snow accumulation from a snow clearance condition in the evaluation section, a condition of spraying of a snow melting agent, and the like. In this event, an associated evaluation value of the likelihood of being stuck is set in advance to each among of snow accumulation. Thus, the controller 201 determines an evaluation value of the likelihood that the vehicle will be stuck in accordance with the estimated amount of snow accumulation.

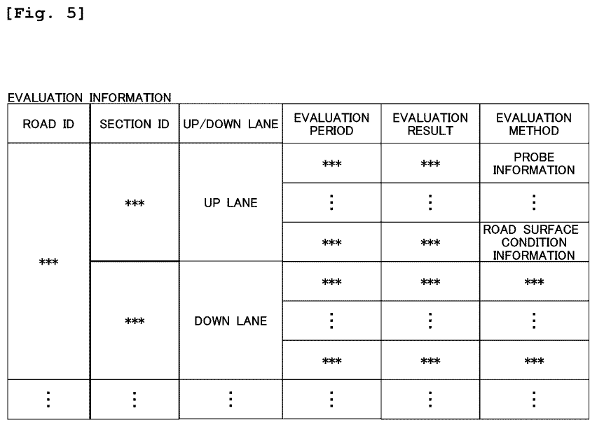

If the controller 201 determines the evaluation value, the controller 201 updates evaluation information held in the evaluation information DB 204. The evaluation information DB 204 has a function of holding the evaluation information. The evaluation information DB 204 can be implemented by the auxiliary memory 230 in the evaluation server 200. FIG. 5 is a diagram indicating an example of a table configuration of the evaluation information held in the evaluation information DB 204.

As indicated in FIG. 5, the evaluation information has a road ID field, a section ID field, an up/down lane field, an evaluation period field, an evaluation result field, and an evaluation method field. In the road ID field, an identifier (road ID) for specifying a road having a plurality of lanes is stored. In the section ID field, an identifier (section ID) for specifying the evaluation section is stored. In the up/down lane field, information indicating whether the section with the corresponding section ID is an up lane or a down lane is stored. In a case where the section with the corresponding section ID is an up lane, information indicating “up lane” is stored in the up/down lane field. Further, in a case where the section with the corresponding section ID is a down lane, information indicating “down lane” is stored in the up/down lane field.

In the evaluation period field, information indicating the evaluation period upon evaluation of a likelihood of being stuck in the evaluation section with the corresponding section ID is stored. In the evaluation result field, information (evaluation value) indicating the evaluation result of the likelihood of being stuck in the evaluation section with the corresponding section ID in the corresponding evaluation period is stored.

In the evaluation method field, information indicating information used upon determination of the evaluation result of the corresponding evaluation result field is stored. In a case where the evaluation result of the corresponding evaluation result field is determined using the probe information, information indicating “probe information” is stored in the evaluation method field. Further, in a case where the evaluation result of the corresponding evaluation result field is determined using the road surface condition information, information indicating “road surface condition information” is stored in the evaluation method field.

The controller 201 adds information regarding the determined evaluation value to the evaluation period field, the evaluation result field, and the evaluation method field in the evaluation information held in the evaluation information DB 204. In this manner, the controller 201 updates the evaluation information.

Further, if the controller 201 determines the evaluation value, the controller 201 generates result information including the evaluation value. Then, the controller 201 outputs the result information to the user terminal 400 via the communicator 202. In this event, the controller 201 acquires an evaluation value in a past evaluation period which is the same hours as hours of the evaluation period of this time with reference to the evaluation information held in the evaluation information DB 204. Here, the controller 201 specifies an evaluation period with the same start time and the same evaluation time limit corresponding to the evaluation period as those of the evaluation period of this time, as the past evaluation period. In a case where the evaluation value of this time is greater than the evaluation value in the past evaluation period by a predetermined value or more, the controller 201 generates result information including information indicating that the likelihood of being stuck in evaluation section is higher than normal. This allows the user to grasp that the likelihood of being stuck in the evaluation section is higher than usual.

Further, in a case where the current evaluation value of the likelihood of being stuck in the evaluation section is greater than the previous evaluation value of the likelihood of being stuck in the evaluation section by a predetermined value or more, the controller 201 may generate result information including information indicating that the likelihood of being stuck in the evaluation section is higher than normal. In this case, the user can grasp that the likelihood of being stuck in the evaluation section is higher than the previous evaluation result.

### (Flowchart)

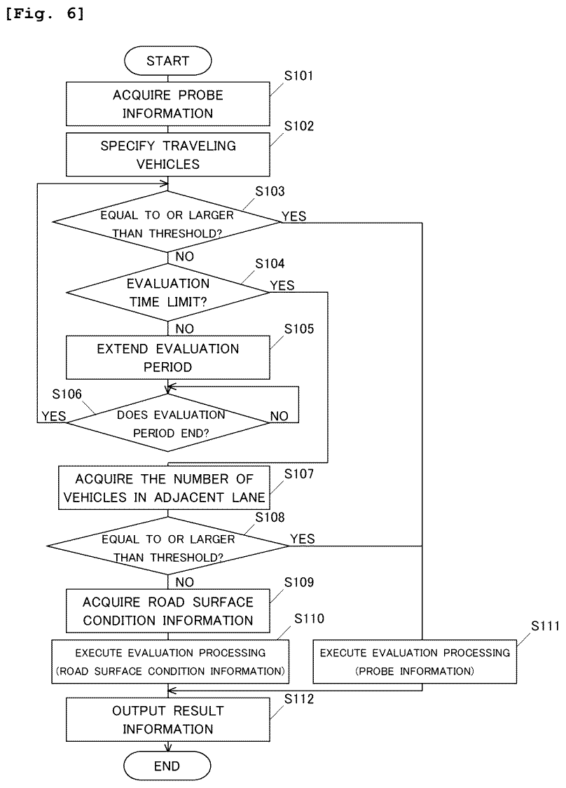

Processing to be executed by the controller 201 of the evaluation server 200 in the evaluation system 1 will be described next based on FIG. 6. FIG. 6 is a flowchart of the processing to be executed by the controller 201. The processing indicated in FIG. 6 is processing of evaluating a likelihood of being stuck in the evaluation section. Execution of the processing indicated in FIG. 6 is started at the start time of the evaluation period.

In the processing indicated in FIG. 6, first, in S101, the probe information is acquired from the probe information DB 203. Then, in S102, the traveling vehicles 10 that have traveled in the evaluation section within the evaluation period are specified. Then, in S103, it is determined whether or not the number of the specified traveling vehicles 10 is equal to or larger than the threshold. In a case where positive determination is made in S103, in S111, processing of evaluating a likelihood of being stuck in the evaluation section is executed using the probe information of the specified traveling vehicles 10.

In a case where negative determination result is made in S103, it is determined in S104 whether or not the evaluation time limit has come. In a case where negative determination is made in S104, the number of the traveling vehicles 10 is less than the threshold, and the evaluation time limit has not come, and thus, the evaluation period is extended in S105. Here, the evaluation period is extended by an amount corresponding to a period determined in advance. Then, in S106, it is determined whether or not the evaluation period has ended. In a case where negative determination is made in S106, the evaluation period has not ended, and thus, the processing in S106 is executed again. In other words, the processing in S106 is repeatedly executed until the evaluation period ends.

In a case where positive determination is made in S106, the extended evaluation period has ended, and thus, it is determined whether or not the number of the traveling vehicles 10 in the evaluation period extended in the processing in S103 is equal to or larger than the threshold. In a case where positive determination is made in S103, the number of the traveling vehicles 10 in the extended evaluation period is equal to or larger than the threshold, and thus, in S111, the evaluation processing is executed using the probe information of the traveling vehicles 10 in the extended evaluation period. Further, in a case where negative determination is made in S103, the processing in S104 is executed again. Then, in a case where negative determination is made in S104, the evaluation period is extended again in S105.

In a case where positive determination is made in S104, the number of the traveling vehicles 10 does not become equal to or larger than the threshold even if the evaluation period is extended up to the evaluation time limit, and thus, the number of the traveling vehicles 10 in the evaluation section of the adjacent lane of the evaluation section is acquired in the processing in S107. Then, in S108, it is determined whether or not the total number is equal to or larger than the threshold. Here, the threshold in S103 may be the same as or different from the threshold in S108.

In a case where positive determination is made in S108, in S111, the likelihood of being stuck in the evaluation section is evaluated in accordance with the probe information of the traveling vehicles 10 in the evaluation section and the traveling vehicles 10 in the evaluation section of the adjacent lane. In a case where negative determination is made in S108, the number of the traveling vehicles 10 sufficient to evaluate the likelihood of being stuck using the probe information cannot be secured in the evaluation section and the evaluation section adjacent to the evaluation section. Thus, in S109, the road surface condition information is acquired from the external server 300. Then, in S110, the evaluation processing using the road surface condition information is executed.

If the evaluation processing is executed in S110 or S111, result information is output to the user terminal 400. In this event, the controller 201 generates result information including indicating information that the likelihood of being stuck in the evaluation section is higher than normal in a case where the evaluation value of this time is greater than the evaluation value in the past evaluation period by a predetermined value or more with reference to the evaluation information held in the evaluation information DB 204. Then, execution of the processing indicated in FIG. 6 ends.

Further, in a case where the evaluation processing is executed, the result information may be output to the user terminal 400 before the provision time. This allows the user to grasp the likelihood of being stuck in the evaluation section earlier.

As described above, by the evaluation system 1, in a case where the number of the traveling vehicles 10 in the evaluation period is less than the threshold, the evaluation period is extended. This helps, even in a case where the number of traveling vehicles existing in the evaluation period is not sufficient to evaluate the likelihood of being stuck in accordance with the probe information, to secure a sufficient number of traveling vehicles by extending the evaluation period. This can prevent the evaluation of the likelihood of being stuck from being impossible.

Further, in a case where the number of the traveling vehicles 10 do not exceed the threshold even if the evaluation period is extended up to the evaluation time limit, the likelihood of being stuck in the evaluation section is evaluated in accordance with the road surface condition information. By this method, even in a case where the number of traveling vehicles existing in the evaluation period is not sufficient to evaluate the likelihood of being stuck in accordance with the probe information, the likelihood of being stuck can be evaluated. In this manner, it is possible to evaluate a likelihood of being stuck on a road more reliably.

### (Modification 1)

The probe information may be information including whether or not a traction control system of the vehicle 10 is activated. Here, an electronic control unit (ECU) of the vehicle 10 detects wheelspin from a speed of the vehicle 10 acquired by the vehicle speed sensor of the vehicle 10 and a wheel speed of the vehicle 10 acquired by the wheel speed sensor of the vehicle 10. In this case, the ECU of the vehicle 10 activates the traction control system. In this event, the in-vehicle device 100 monitors activation of the traction control system in real time. The in-vehicle device 100 transmits an activation condition of the traction control system to the evaluation server 200 in real time as the probe information. In this manner, the in-vehicle device 100 transmits the probe information in accordance with a sensing value of the sensor mounted on the vehicle 10 to the evaluation server 200 in real time.

Then, in a case where the traction control system is activated in the evaluation section, the evaluation server 200 evaluates the evaluation section as a section in which the vehicle is likely to be stuck. Also by this method, the likelihood of being stuck in the evaluation section can be evaluated more reliably.

### (Modification 2)

In the present embodiment, the likelihood of being stuck in the evaluation section is evaluated in accordance with the road surface condition information. In the present modification, the likelihood of being stuck in the evaluation section is evaluated in accordance with the past evaluation result instead of the road surface condition information. Hereinafter, only differences from the present embodiment will be described.

The evaluation server 200 acquires evaluation information held in the evaluation information DB 204 instead of acquiring the road surface condition information from the external server 300. Then, the evaluation server 200 acquires evaluation of the likelihood of being stuck in the evaluation section in the past evaluation period which is the same hours as hours of the evaluation period. Here, the evaluation server 200 acquires an average value of evaluation results in a case where there is a plurality of past evaluation periods which is the same hours as the hours of the evaluation period. Further, the evaluation server 200 may set the previous evaluation result as the evaluation result of this time. Also by this method, the likelihood of being stuck in the evaluation section can be evaluated more reliably.

Note that the evaluation server 200 may evaluate the likelihood of being stuck in the evaluation section in accordance with both the road surface condition information and the evaluation information. In this case, the evaluation information further includes information indicating a road surface condition in the evaluation period. The evaluation server 200 acquires the road surface condition in the evaluation period from the road surface condition information and specifies the past evaluation period with the same road surface condition as the road surface condition. Then, the evaluation server 200 outputs the result information in which the evaluation result in the specified past evaluation period is set as the evaluation result of the likelihood of being stuck in the evaluation section.

### (Modification 3)

In the present embodiment, the result information in the evaluation period is output to the user terminal 400 at a time point at which the number of the traveling vehicles 10 existing in the evaluation period is equal to or larger than the threshold, and evaluation of the likelihood of being stuck in the evaluation section ends. On the other hand, in the present modification, the evaluation period is extended up to the evaluation time limit even after the traveling vehicles 10, the number of which is equal to or larger than the threshold, exist in the evaluation period, and the result information in each evaluation period is output to the user terminal 400. Note that in a case where the number of the traveling vehicles 10 existing in the evaluation period is not equal to or larger than the threshold, the evaluation period is extended up to the evaluation time limit in a similar manner to the present embodiment without the result information being output.

By this method, the user can receive a flash report of the evaluation result in the evaluation period in which the number of the traveling vehicles 10 becomes equal to or larger than the threshold first. Further, as the evaluation period is extended to be longer, the number of the traveling vehicles 10 becomes larger. Thus, as the evaluation period is extended to be longer, it is assumed that the evaluation result becomes more accurate. Thus, as a result of the result information in each evaluation period being output to the user terminal 400, result information including a more accurate evaluation result is output to the user terminal 400. This results in making it possible for the user to grasp a more accurate evaluation result.

### (Modification 4)

In the present embodiment, the evaluation server 200 executes the evaluation processing using the probe information in a case where the number of the traveling vehicles 10 is equal to or larger than the threshold. Further, the evaluation server 200 executes the evaluation processing using the road surface condition information in a case where the number of the traveling vehicles 10 is less than the threshold. However, the evaluation server 200 may execute the evaluation processing using the probe information in a case where the number of the traveling vehicles 10 exceeds the threshold and may execute the evaluation processing using the road surface condition information in a case where the number of the traveling vehicles 10 is less than the threshold. Further, in this case, in a case where the number of the traveling vehicles 10 is equal to the threshold, either of the evaluation processing may be executed.

### (Modification 5)

The prevalence of snow chains, studless tires, or the like varies depending on the area to which the evaluation section belongs, and it is assumed that a likelihood of being stuck differs even with the same amount of snow accumulation. Further, snow quality varies depending on the area, and thus, it is assumed that a likelihood of being stuck differs even with the same amount of snow accumulation. Still further, a usage rate of snow chains, studless tires, or the like becomes high in a season in which snow accumulation is expected in highlands such as mountain areas, and thus, it is assumed that a likelihood of being stuck differs from that in lowlands.

Thus, the evaluation server 200 may evaluate the likelihood of being stuck in the evaluation section in accordance with the area to which the evaluation section belongs. Specifically, the evaluation server 200 evaluates the likelihood of being stuck in the evaluation section in accordance with an evaluation value of the likelihood of being stuck which is set for each area to which the evaluation section belongs and which is associated with each amount of snow accumulation. Here, the area to which the evaluation section belongs is classified in accordance with the region or the altitude of the evaluation section. Also by this method, the user can grasp a more accurate evaluation result.

### (Modification 6)

In the present embodiment, an output destination of the result information is the user terminal 400. However, the output destination of the result information does not necessarily have to be the user terminal 400. The output destination of the result information may be a terminal to be used by an administrator of the road. Further, the output destination of the result information may be, for example, a server device that delivers the evaluation result of slippiness of the vehicle to the user.

### Other Embodiments

The above-described embodiment is merely an example and can be implemented with changes made as appropriate within the scope not deviating from the gist of the present disclosure. Further, the processing and method described in the present disclosure can be freely combined and implemented unless technical inconsistencies arise.

Further, the processing described as being performed by one device may be shared and executed by a plurality of devices. Alternatively, the processing described as being performed by different devices may be executed by one device. In a computer system, what kind of hardware configuration (server configuration) is used to implement each function can be flexibly changed.

The present disclosure can also be implemented by supplying a computer program that implements the functions described in the above-described embodiment to a computer, and one or more processors of the computer reading and executing the program. Such a computer program may be provided to the computer by a non-transitory computer-readable storage medium which is connectable to a system bus of the computer or may be provided to the computer via a network. The non-transitory computer-readable storage medium includes, for example, an arbitrary type of disk such as a magnetic disk (such as a Floppy (registered trademark) disk or a hard disk drive (HDD)) and an optical disk (such as a CD-ROM, a DVD disk or a Blu-ray disc) and an arbitrary type of medium appropriate for storing an electronic command, like a read only memory (ROM), a random access memory (RAM), an EPROM, an EEPROM, a magnetic card, a flash memory or an optical card.

What is claimed is:

1. An information processing apparatus comprising a controller configured to execute:
receiving in real time, probe information including a position acquired by a GPS device mounted on each of vehicles and a sensing value acquired by an in-vehicle sensor of each of the vehicles;
storing the probe information of the vehicles in a database;
specifying traveling vehicles in an evaluation section in an evaluation period for evaluating a likelihood of being stuck with reference to positions of the vehicles stored in the database;
extending the evaluation period in a range up to an evaluation time limit in a case where the number of the traveling vehicles is less than a threshold;
in a case where the number of the traveling vehicles exceeds the threshold, evaluating a likelihood of being stuck in the evaluation section in accordance with probe information when a plurality of the traveling vehicles is traveling in the evaluation section, the probe information being stored in the database; and
outputting result information of the evaluation to an external apparatus.

2. An information processing apparatus comprising a controller configured to execute:
determining whether or not the number of traveling vehicles in an evaluation section in an evaluation period for evaluating a likelihood of being stuck exceeds a threshold;
extending the evaluation period in a case where the number of the traveling vehicles is less than the threshold;
in a case where the number of the traveling vehicles exceeds the threshold, evaluating a likelihood of being stuck in the evaluation section in accordance with probe information when a plurality of the traveling vehicles is traveling in the evaluation section; and
outputting result information of the evaluation.

3. The information processing apparatus according to claim 2, wherein the controller is configured to further execute:
in a case where the number of the traveling vehicles is less than the threshold even if the evaluation period is extended up to the evaluation time limit,
prohibiting evaluation of the likelihood of being stuck in the evaluation section in accordance with the probe information of the plurality of traveling vehicles; and
evaluating the likelihood of being stuck in the evaluation section in accordance with at least one of a road surface condition of the evaluation section in the evaluation period and an evaluation result of the likelihood of being stuck in the evaluation section in the past.

4. The information processing apparatus according to claim 3, wherein evaluating the likelihood of being stuck in the evaluation section in accordance with at least one of the road surface condition of the evaluation section in the evaluation period and the evaluation result of the likelihood of being stuck in the evaluation section in the past includes evaluating the likelihood of being stuck in the evaluation section in accordance with the road surface condition of the evaluation section in the evaluation period and an area to which the evaluation section belongs.

5. The information processing apparatus according to claim 2, wherein
the evaluation section is set for each lane in the same road section, and
evaluating the likelihood of being stuck in the evaluation section includes in a case where the number of traveling vehicles in a first evaluation section that is at least one of the evaluation sections is less than the threshold, and a sum of the numbers of the traveling vehicles in the evaluation sections in the evaluation period exceeds the threshold, evaluating a likelihood of being stuck in the first evaluation section in accordance with probe information of the traveling vehicles in the evaluation sections.

6. The information processing apparatus according to claim 3, wherein
the evaluation section is set for each lane in the same road section, and
evaluating the likelihood of being stuck in the evaluation section includes in a case where the number of traveling vehicles in a first evaluation section that is at least one of the evaluation sections is less than the threshold, and a sum of the numbers of the traveling vehicles in the evaluation sections in the evaluation period exceeds the threshold, evaluating a likelihood of being stuck in the first evaluation section in accordance with probe information of the traveling vehicles in the evaluation sections.

7. The information processing apparatus according to claim 4, wherein
the evaluation section is set for each lane in the same road section, and
evaluating the likelihood of being stuck in the evaluation section includes in a case where the number of traveling vehicles in a first evaluation section that is at least one of the evaluation sections is less than the threshold, and a sum of the numbers of the traveling vehicles in the evaluation sections in the evaluation period exceeds the threshold, evaluating a likelihood of being stuck in the first evaluation section in accordance with probe information of the traveling vehicles in the evaluation sections.

8. The information processing apparatus according to claim 2, wherein outputting the result information includes in a case where evaluation of the likelihood of being stuck in the evaluation section in the evaluation period is higher than evaluation of a likelihood of being stuck in the evaluation section in a past evaluation period which is the same hours in the past by a predetermined value or more, outputting information indicating that the likelihood of being stuck in the evaluation section is higher than normal.

9. The information processing apparatus according to claim 3, wherein outputting the result information includes in a case where evaluation of the likelihood of being stuck in the evaluation section in the evaluation period is higher than evaluation of a likelihood of being stuck in the evaluation section in a past evaluation period which is the same hours in the past by a predetermined value or more, outputting information indicating that the likelihood of being stuck in the evaluation section is higher than normal.

10. The information processing apparatus according to claim 4, wherein outputting the result information includes in a case where evaluation of the likelihood of being stuck in the evaluation section in the evaluation period is higher than evaluation of a likelihood of being stuck in the evaluation section in a past evaluation period which is the same hours in the past by a predetermined value or more, outputting information indicating that the likelihood of being stuck in the evaluation section is higher than normal.

11. The information processing apparatus according to claim 2, wherein
the controller is configured to further execute evaluating the likelihood of being stuck in the evaluation section in the corresponding evaluation period at each evaluation time, and
outputting the result information includes in a case where evaluation of the likelihood of being stuck in the evaluation section at a current evaluation time is higher than evaluation of a likelihood of being stuck in the evaluation section at a previous evaluation time by a predetermined value or more, outputting information indicating that the likelihood of being stuck in the evaluation section is higher than normal.

12. The information processing apparatus according to claim 3, wherein
the controller is configured to further execute evaluating the likelihood of being stuck in the evaluation section in the corresponding evaluation period at each evaluation time, and
outputting the result information includes in a case where evaluation of the likelihood of being stuck in the evaluation section at a current evaluation time is higher than evaluation of a likelihood of being stuck in the evaluation section at a previous evaluation time by a predetermined value or more, outputting information indicating that the likelihood of being stuck in the evaluation section is higher than normal.

13. The information processing apparatus according to claim 4, wherein
the controller is configured to further execute evaluating the likelihood of being stuck in the evaluation section in the corresponding evaluation period at each evaluation time, and
outputting the result information includes in a case where evaluation of the likelihood of being stuck in the evaluation section at a current evaluation time is higher than evaluation of a likelihood of being stuck in the evaluation section at a previous evaluation time by a predetermined value or more, outputting information indicating that the likelihood of being stuck in the evaluation section is higher than normal.
